(19) United States
(12) Patent Application Publication
(10) Pub. No.: US 2024/0398638 A1
(43) Pub. Date: Dec. 5, 2024

(54) MULTI-MODE WHEELCHAIR

(71) Applicant: TUNG KENG ENTERPRISE CO., LTD., TAICHUNG (TW)

(72) Inventor: CHIU-HSIANG LO, TAICHUNG (TW)

(21) Appl. No.: 18/473,298

(22) Filed: Sep. 25, 2023

(30) Foreign Application Priority Data
Jun. 5, 2023 (TW) 112205659

(51) Int. Cl. A61G 5/08; A61G 5/04; A61G 5/10; A61H 3/04

(52) U.S. Cl. CPC A61G 5/0825; A61G 5/045; A61G 5/1032; A61H 3/04; A61H 2003/046

(57) ABSTRACT

A multi-mode wheelchair includes a frame, two front wheels, two rear wheels and two driver units. The frame includes an intermediate unit for interconnecting two side units. The intermediate unit is movable between a collapsed position and an extended position. The front wheels are connected to the side units. The rear wheels are connected to the side units. The driver units are connected to the side units. Each of the driver units includes a motor located in a corresponding one of the rear wheels and a brake operable to stop the motor. The driver units are located between the rear wheels. A distance between the driver units is larger than a breadth of a user when the intermediate unit is in the extended position.

### BACKGROUND OF INVENTION

### 1. Field Of Invention

The present invention relates to a wheelchair and, more particularly, to a multi-mode wheelchair that can be used as a walker.

### 2. Related Prior Art

Taiwanese Patent No. M540633 discloses a clutch mechanism for a wheelchair. The clutch mechanism allows easy detachment of two wheels from a chair of the wheelchair for storage or carriage. The clutch mechanism allows easy attachment of the wheels to the chair for use. However, the clutch mechanism is located between the wheels and tends to hinder a user's legs when he or she tries to use the wheelchair as a walker.

Taiwanese Patent No. M536166 discloses an adjusting device operable to switch a wheelchair between an electric mode and a manual mode. The switching device is located between a hub and a driving mechanism. In the automatic mode, the driving mechanism is allowed to rotate the hub. In the manual mode, the hub is disconnected from the driving mechanism. However, the size of the hub, the driving mechanism and the adjusting device is large. Moreover, two such combinations are located between two wheels of the wheelchair and tend to hinder a user's legs when he or she tries to use the wheelchair as a walker.

The present invention is therefore intended to obviate or at least alleviate the problems encountered in the prior art.

### SUMMARY OF INVENTION

It is the primary objective of the present invention to provide a multi-mode wheelchair that can be used as a walker.

To achieve the foregoing objective, the multi-mode wheelchair includes a frame, two front wheels, two rear wheels and two driver units. The frame includes an intermediate unit for interconnecting two side units. The intermediate unit is movable between a collapsed position and an extended position. The front wheels are connected to the side units. The rear wheels are connected to the side units. The driver units are connected to the side units. Each of the driver units includes a motor located in a corresponding one of the rear wheels and a brake operable to stop the motor. The driver units are located between the rear wheels. A distance between the driver units is larger than a breadth of a user when the intermediate unit is in the extended position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a multi-mode wheelchair according to the preferred embodiment of the present invention;

FIG. 2 is a rear view of the wheelchair shown in FIG. 1;

FIG. 3 is a top view of the wheelchair shown in FIG. 1; and

FIG. 4 is a side view of a power wheel module shown in FIG. 1.

### DETAILED DESCRIPTION OF PREFERRED EMBODIMENT

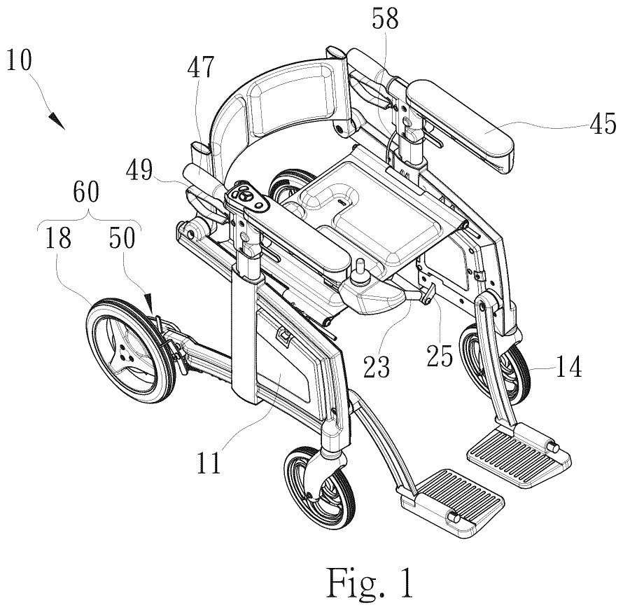

Referring to FIGS. 1 through 3, a multi-mode wheelchair 10 includes a frame, two front wheels 14 and two power wheel modules 60 according the preferred embodiment of the present invention. The frame includes two side units 11 interconnected by an intermediate unit 20.

Each of the side units 11 includes an upper portion provided with an armrest 45, a grip 47 and a brake lever 49. The grip 47 is located behind the armrest 45. The brake lever 49 is located below the grip 47. Each of the front wheels 14 is connected to a front lower portion of one of the side units 11. Each of the power wheel muddles 60 is connected to a rear lower portion of one of the side units 11.

The intermediate unit 20 includes two rods 21 and 23. The rod 21 includes an upper end pivotally connected to a seat rod 24 of the left-side unit 11 and a lower end pivotally connected to a lug 25 of the right-side unit 11. The rod 23 includes an upper end pivotally connected to a seat rod 24 of the right-side unit 11 and a lower end pivotally connected to a lug of the left-side unit 11. The rods 21 and 23 are pivotally connected to each other like an “X” so that the intermediate unit 20 is movable between an extended position and a collapsed position. The side units 11 are further from each other when the intermediate unit 20 is in the extended position than when the intermediate unit 20 is in the collapsed position.

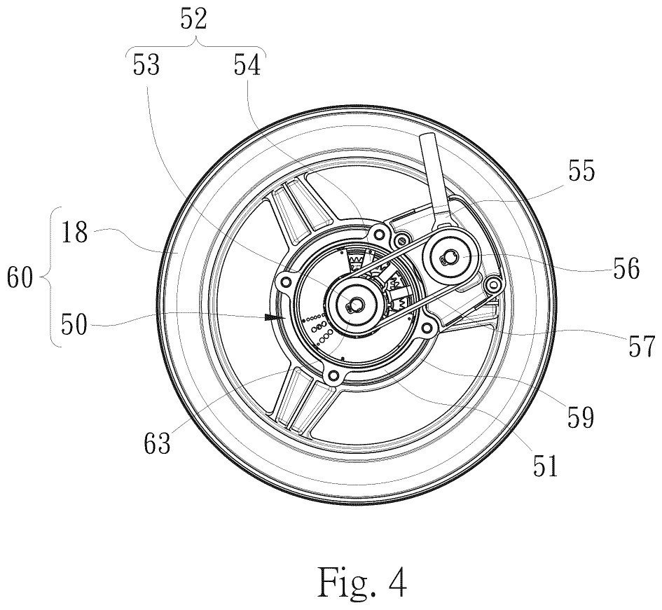

Referring to FIG. 4, each of the power wheel modules 60 includes a rear wheel 18 and a driver unit 50. The rear wheel 18 includes a hub 59. The driver unit 50 includes a shell 51 includes a rear portion located in the hub 59 and a front portion connected to the rear lower portion of one of the side units 11.

A motor 52 is located in the rear portion of the shell 51. The motor 52 includes a rotor 53 coaxially located in a stator 54 located in the rear portion of the shell 51. A pulley 63 is connected to the rotor 53.

A brake 55 is pivotally connected to the front portion of the shell 51. A brake pulley 56 is operatively connected to the brake 55. The brake pulley 56. A belt 57 is wound around the pulley 63 and the brake pulley 56 so that the pulleys 63 and 56 are rotated or stopped with each other. The brake 55 is connected to the brake lever 49 via a cable 58. The brake lever 49 is operable to stop the brake pulley 56 which in turn stops the pulley 63 via the belt 57. That is, the brake 55 stops the motor 52 and the rear wheel 18.

In another embodiment, gears (or toothed wheels) can be used instead the pulleys 56 and 63 and a chain can be used instead of the belt 57. Other mechanisms can be used instead of the combination of the pulleys 56 and 63 with the belt 57.

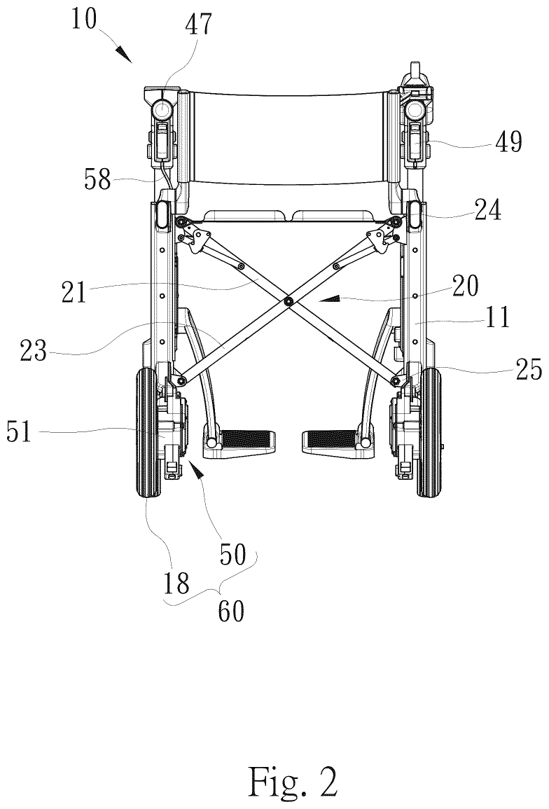

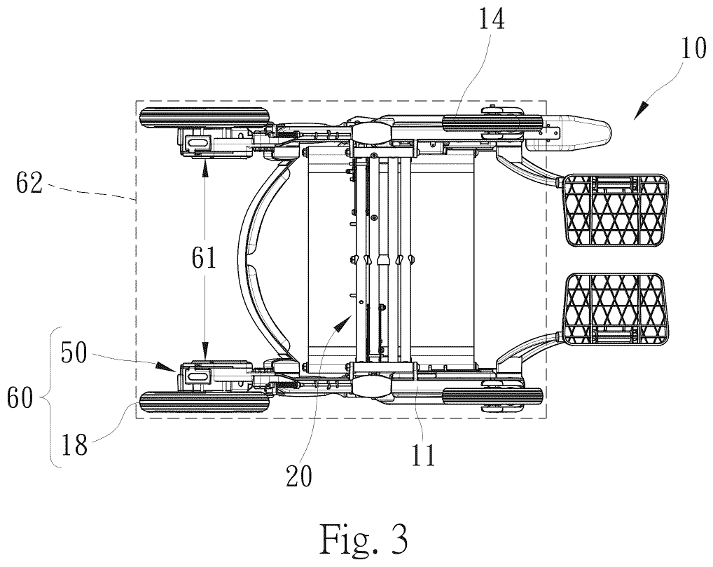

Referring to FIGS. 2 and 3, the driver units 50 are located between the rear wheels 18. When the intermediate unit 20 is in the extended position, there is a distance 61 between the driver units 50 and the wheelchair is in a total breadth 62.

A user can of course sit in the multi-mode wheelchair 10 and use it as a wheelchair. The user can use the multi-mode wheelchair 10 as a walker. In this case, a user holds the grips 47 and walks behind the multi-mode wheelchair 10. It is easier for the user to walk with help from the multi-mode wheelchair 10 than without. The user can operate the brake levers 49 to stop the multi-mode wheelchair 10.

While waking with help from the multi-mode wheelchair 10, the user's feet are located between the driver units 50. The distance 61 is adequate to prevent the driver units 50 from hindering the feet of the user. Preferably, the distance 61 is larger than a user's breadth. Moreover, the total breadth 62 is adequate to allow stable movement of the multi-mode wheelchair 10 and the user.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A multi-mode wheelchair comprising:
a frame comprising two side units and an intermediate unit for interconnecting the side units, wherein the intermediate unit is movable between a collapsed position and an extended position;
two front wheels connected to the side units;
two rear wheels connected to the side units; and
two driver units connected to the side units, wherein each of the driver units comprises motor located in one of the rear wheels and a brake operable to stop the motor, wherein the driver units are located between the rear wheels, wherein a distance between the driver units is larger than a breadth of a user when the intermediate unit is in the extended position.

2. The multi-mode wheelchair according to claim 1, wherein each of the driver units comprises a shell for receiving the motor.

3. The multi-mode wheelchair according to claim 2, wherein each of the rear wheels comprises a hub for receiving a corresponding one of the shells.

4. The multi-mode wheelchair according to claim 1, wherein each of the driver units comprises a first pulley operatively connected to the motor, a second pulley operatively connected to the brake, and a belt wound around the pulleys, wherein the bake is operable to stop the second pulley.

5. A multi-mode wheelchair comprising:
a frame comprising two side units and an intermediate unit for interconnecting the side units;
two front wheels connected to the side units;
two rear wheels connected to the side units; and
two driver units connected to the side units, wherein each of the driver units comprises a motor located in one of the rear wheels, a first pulley operatively connected to the motor, a second pulley operatively connected to the brake, and a belt wound around the first and second pulleys, and a brake operable to stop the second pulley, wherein the driver units are located between the rear wheels, wherein a distance between the driver units is larger than a breadth of a user.

6. The multi-mode wheelchair according to claim 5, wherein each of the driver units comprises a shell for receiving the motor.

7. The multi-mode wheelchair according to claim 6, wherein each of the rear wheels comprises a hub for receiving a corresponding one of the shells.
